(19) United States
(12) Patent Application Publication
(10) Pub. No.: US 2011/0223398 A1
(43) Pub. Date: Sep. 15, 2011

(54) Upholstery and Wall Panel Weight Woven Fabrics

(75) Inventor: J. Michael Dobin, Pompano Beach, FL (US)

(73) Assignee: VALLEY FORGE FABRICS, INC., Pompano Beach, FL (US)

(21) Appl. No.: 12/751,423

(22) Filed: Mar. 31, 2010

Related U.S. Application Data
(60) Provisional application No. 61/312,018, filed on Mar. 9, 2010.

(51) Int. Cl. B32B 3/10; D03D 15/00

(52) U.S. Cl. 428/196; 442/181; 442/209

(57) ABSTRACT

A woven fabric includes a warp formed of natural or manmade fiber and a weft formed lyocell fiber or a blend of lyocell fiber and at least one other fiber.

### CROSS-REFERENCE TO RELATED APPLICATION

This application claims the priority under 35 U.S.C. 119(e) of U.S. Provisional Patent Application No. 61/312,018, filed Mar. 9, 2010.

### BACKGROUND OF THE INVENTION

1. Field of the Invention

The invention relates to a high durability, heavy weight fabric to be used for upholstering furniture and wall panels.

2. Description of the Related Art

In the past, it has been a challenge to create heavy duty fabrics with increased abrasion strength using cotton or rayon. In addition, it has always been a challenge to control the strength of rayon under wet yarn dyeing and or piece dyeing procedures since rayon tends to lose its strength when wet.

What is needed for such woven fabrics experiencing high wear and tear, is a fiber which has excellent strength, is washable, is shrink resistant, has a soft hand, has an excellent drape, is absorbent and carries antibacterial attributes. Lyocell fiber has such properties, but the use of lyocell as a woven fabric in the weight required for upholstered furniture and wall panels in unknown in the prior art.

Several disclosures in the prior art, such as U.S. Patent Application Publication Nos. US 2007/0004302; US 2007/0105469 and US 2008/0090076, International Publication No. WO 2008/019412 and Japanese Patent Publication No. JP 10-53934 mention the use of lyocell as filler material. U.S. Pat. No. 7,067,444 relates to the use of lyocell for a nonwoven fabric. Other disclosures, such as International Publication Nos. WO 03/099047 and 03/078720, U.S. Patent Application Publication Nos. US 2004/0176008; US 2005/0095936 and 2005/0118919 and Japanese Patent Publication No. JP-10-18145 mentioned the use of lyocell for clothing, linings, mattress covers and ticking. Finally, several other disclosures mention the use of lyocell for wall coverings or furniture, such as U.S. Patent Application Publication Nos. US 2008/0299854; 2008/0299854; 2008/0096001; 2007/0248819; 2005/0227558; 2007/0082574; 2009/0004474 and 2008/0085651 as well as U.S. Pat. Nos. 7,326,664; 7,225,487 and 7,150,059 and International Publication No. WO 2009/059342 A1, but as a non-woven fabric.

### BRIEF SUMMARY OF THE INVENTION

It is accordingly an object of the invention to provide an upholstery and wall panel weight woven fabric, which overcomes the hereinafore-mentioned disadvantages of the heretofore-known devices and methods of this general type and which meets the requirements of durability, shrink-resistance, excellent drape, washability, soft hand, absorbency and bacterial resistance.

These objects have been accomplished, according to the invention, by developing woven yarn dyed jacquards and dobbies in durable constructions, using lyocell fiber blends, for heavy wear and tear. To date, there have been no products made by using 100% lyocell or lyocell blended with other fibers to create high durability heavy weight woven fabrics used for upholstering furniture and wall panels.

Lyocell is a man-made fiber. It is cellulosic based (made from dissolved wood pulp on the solvent spinning system). lyocell is a generic fiber name and is defined by the Federal Trade Commission as:

A cellulose fiber obtained by an organic solvent spinning process where:
1)“Organic solvent” means a mixture of organic chemicals and water, and
2)“solvent spinning” means dissolving and spinning without the formation of a derivative.

Lyocell fiber is known to have excellent strength, washability, shrink resistance, soft hand, drape, absorbency and antibacterial attributes.

Although it has never before been used in furniture and wall upholstery, lyocell is widely used in woven and knitted clothing and sheeting. In clothing and sheeting, lyocell is substituted for other fibers to give the fabric a softer hand. Lyocell is a man-made fiber and thus has a smooth surface that also gives a luster and a silky feeling to fabrics.

Lyocell is also used widely in mattress ticking. Mattresses made with lyocell are more breathable, soft and is believed to have to have antibacterial properties.

Lyocell fiber is used as a filling material in pillow and duvet inserts. The soft properties of lyocell helps the inserts to have a down-like (soft feather-like) feeling.

The purpose of using lyocell in upholstery according to the present invention is to increase the abrasion strength of the fabrics. It has been a challenge to create heavy duty fabrics using cotton or rayon in the past. The present invention has substituted those yarns with lyocell or lyocell blended yarns in the fill to increase the resistance to abrasion and create a heavy duty fabric.

The present invention uses various constructions, designs and patterns with this lyocell and lyocell blend product. These constructions for the woven fabric include, but are not limited to:
100% recycled polyester or virgin polyester warp with lyocell or lyocell blend fill yarns.
100% recycled polyester or virgin polyester warp with lyocell or lyocell blend fill yarns that are interspersed with other non-lyocell fill yarns.
100% nylon warp with lyocell or lyocell blend fill yarns.
100% nylon warp with lyocell or lyocell blend fill yarns interspersed with non-lyocell fill yarns.

Some warps being used are solid color, some end on end, and some can be tapestry warps. There are some cases where a combination of polyester and nylon, or a combination of polyester and cotton, or 100% cotton, could be used as a warp with these lyocell possibilities in the fill. Constructions can be yarn dyed or piece dyed. Constructions can be jacquards or dobbies. Constructions can range from flat to chenille, boucle, or other novelty fill yarns.

In the development of the present invention, a litany of testing requirements has been set for a textile to meet durability and industry requirements. The technical requirements are listed below, but even before a product is tested to determine if it meets these requirements, there are basic requirements that the product must adhere to:
Color matching must stay consistent.
Technical testing must remain consistent from one production lot to the next.
Pattern matching must remain consistent from one lot to the next.
Yarns must remain consistent in terms of twists and dyability to avoid finished fabric issues.

A new development for a fill yarn can be difficult since there can be various issues that can arise:
Pilling
Snagging
Inability to wash out certain light stains easily
Color variability and inconsistency
Failures in durability and double rubs
Failure in basic crocking and light fastness

Since lyocell has never been experimented with as a weft/filling yarn for heavy duty upholsteries, certain weave techniques are required to ensure passing results on technical testing.

Technical testing requirements that textiles in high traffic areas are required to meet are listed below:
ASTM D4157 Abrasion resistance (Double Rub Test)—Minimum of 30,000 double rubs to be considered heavy duty.
ASTM D3884-01 Abrasion Resistance of Textile Fabrics (Rotary Platform, Double Head Method (Taber Test))—5,000 cycles for heavy duty.
ASTM D4034 and D3597 Seam Slippage Test—ACT standards call for a minimum of 25 pounds in warp and weft, and applicant has a self-imposed minimum of 35 pounds in warp and weft for this test.
ASTM D5362 Bean Bag Snag Test.
ASTM D3511 Brush Pill—Minimum of 3.0.
AATCCC 8 Wet and Dry Crocking test—Dry crock must meet a minimum of 4.0. Dry Crocking must meet a minimum of 3.5.
AATCC 16H Colorfastness to light—Must meet a minimum of 40 hours at grade 4.0.
ASTM D2261 Tongue Tear Test—Minimum of 8 pounds.
ASTM D5034-95 Tensile Strength/Breaking strength test—Minimum 35 pounds.
FR code of California bulletin 117 Section E must be met or exceeded.
Fr code of UFAC NFPA 260 must be met or exceeded.
In certain end uses, NFPA 260 or NFPA 701 flame codes must be met or exceeded, either using topical FR treatments or inherent FR yarns in either the warp or partially in the filling or both.

Lyocell has been used in the past in sheeting, filled products, and in clothing applications. Clothing and sheeting do not require the same abrasion, seam, and heavy duty wear testing that woven textiles for upholstery, wall paneling, and the other end uses require. The yarns require specific twisting requirements to increase durability. For example, a 20/2 yarn will require more than 10 twists per inch to reach heavy duty durability standards, whereas 6.2 twists per inch would be just sufficient for clothing.

In addition, it has always been a challenge to control the strength of rayon under wet yarn dyeing and or piece dyeing procedures. Rayon tends to lose its strength when wet, whereas applicant has found out that lyocell performed much better than rayon and cotton when wet.

With the foregoing and other objects in view there is provided, in accordance with the invention, a woven fabric, comprising a warp formed of natural or manmade fiber and a weft formed lyocell fiber or a blend of lyocell fiber and at least one other fiber.

Such a fabric provides the wear and tear, strength, washability, shrink resistance, hand, drape, absorbency and antibacterial attributes required of high durability, heavy weight fabrics used for upholstering furniture and wall panels.

In this regard, natural fibers include, for example, cotton, wool, hemp, linen and silk. Manmade fibers include natural and synthetic manmade fibers. Synthetic manmade fibers include polyester, nylon and acrylic. Natural manmade fibers include cellulose fibers, such as rayon (viscose) and lyocell.

In accordance with another feature of the invention, the warp is formed of a synthetic fiber or a cotton fiber and the weft is formed of a lyocell fiber or a lyocell blended fiber.

In accordance with a further feature of the invention, the warp is formed of a fiber selected from the group consisting of:
a) virgin polyester, recycled polyester or virgin polyester blended with recycled polyester;
b) virgin nylon (polyamide), recycled nylon or virgin nylon blended with recycled nylon;
c) virgin acrylic, recycled acrylic or virgin nylon blended with recycled nylon;
d) lyocell;
e) cotton; and
f) polyester and cotton blended fiber or polyester and cotton yarns used intermittently.

In accordance with an added feature of the invention, the weft is formed of a fiber selected from the group consisting of:
a) 100% lyocell;
b) lyocell fiber blended with polyester;
c) lyocell fiber blended with recycled polyester;
d) lyocell fiber blended with nylon or recycled nylon;
e) lyocell fiber blended with cotton; and
f) lyocell fiber blended with acrylic.

In accordance with an additional feature of the invention, the weft is intermittently used with a fiber selected from the group consisting of:
a) virgin polyester, recycled polyester or virgin polyester blended with recycled polyester;
b) virgin nylon (polyamide), recycled nylon or virgin nylon blended with recycled nylon;
c) virgin acrylic, recycled acrylic or virgin nylon blended with recycled nylon;
d) lyocell;
e) cotton; and
f) polyester and cotton blended yarn or yarn used intermittently.

In accordance with yet another feature of the invention, the warp has a density range of from 25 to 330 yarns per inch, depending size and type of yarns used in the warp.

In accordance with yet a further feature of the invention, the weft has a density range of from 10 to 180 yarns per inch, depending size and type of yarns used in the weft.

In accordance with yet an added feature of the invention, the fabric is woven as a plain weave, a basket weave, a dobby or a jacquard.

In accordance with yet an additional feature of the invention, the fabric includes yarns of different color.

In accordance with again another feature of the invention, the fabric is piece dyed.

In accordance with a concomitant feature of the invention, the fabric is printed.

Other features which are considered as characteristic for the invention are set forth in the appended claims.

Although the invention is illustrated and described herein as embodied in an upholstery and wall panel weight woven fabric, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a group of diagrams showing the strength of lyocell as compared to cotton and rayon;

FIGS. 2A and 2B are photographs showing comparative testing results for lyocell and rayon; and

FIGS. 3A and 3B are photographs showing comparative testing results for lyocell and cotton.

### DETAILED DESCRIPTION OF THE INVENTION

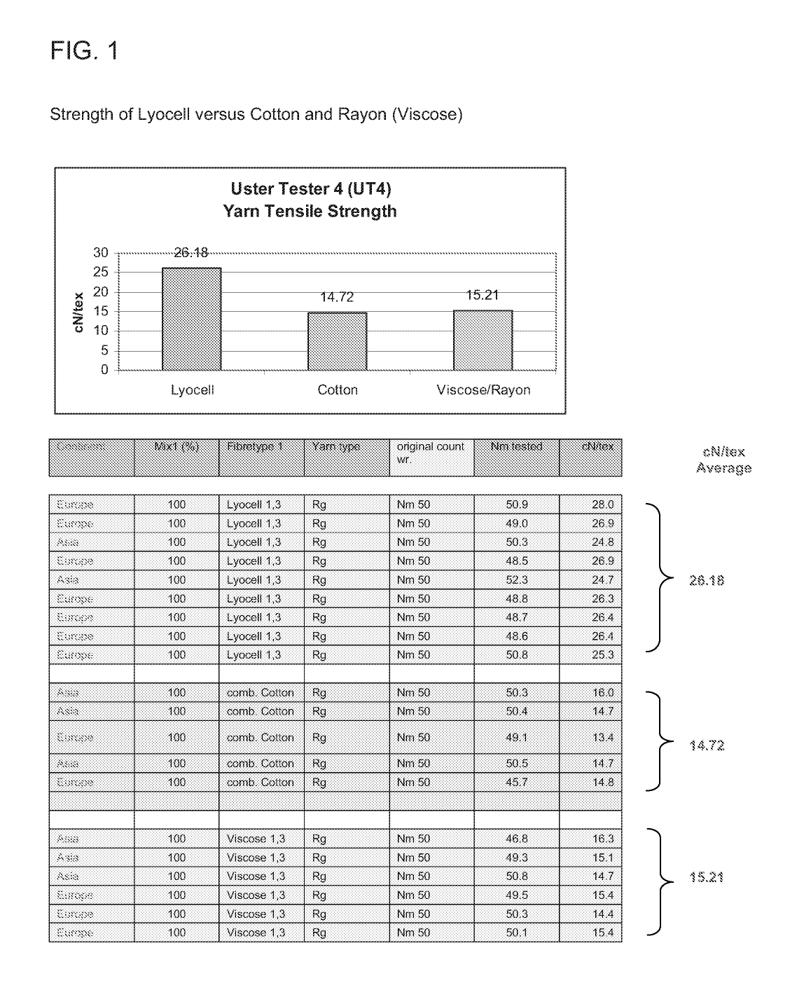

Referring now to the figures of the drawing in detail and first, particularly, to FIG. 1 thereof, there is seen a group of diagrams illustrating the strength of lyocell compared to cotton and rayon.

As mentioned above, it has always been a challenge to control the strength of rayon under wet yarn dyeing and/or piece dyeing procedures. That is because rayon tends to lose its strength when wet, where it has been found out that lyocell performed much better than rayon and cotton when wet. Tests of the strength of lyocell and as compared to that of cotton and rayon (Viscose) were performed.

FIG. 1 shows the performance of 100% lyocell, cotton and rayon in Ne 30's ring spun. All yarns were tested under the same conditions: standard tests made on an Uster Tester 4 (UT4), wherein the specific yarn tensile strength (cN/tex) was an average of 50 tests, for a normal test speed. When viewing the average performance, it is seen that the average yarn tensile strength of lyocell came out to 26.18 cN/tex whereas cotton scored 14.72 cN/tex and viscose rayon averaged 15.21 cN/tex. Due to these convincing results, lyocell was substituted in place of cotton and/or rayon according to the present invention to create a more durable upholstery.

The facts supporting the strength of lyocell in upholstery will be explained in the following.

In order to make textile specification easier, the ACT (Association for Contract Textiles) member companies adopted a body of popular tests that measure important performance criteria for textiles in the contract interior textiles market. The guidelines are a selection of the numerous tests for textile performance that have been established (and are periodically reviewed) by standards organizations, such as ASTM (American Society for Testing and Materials: www.astm.org) and AATCC (American Association of Textile Chemists and Colorists: www.aatcc.org).

For Heavy Duty abrasion ACT requires the testing method:

ASTM D4157-02 (ACT approved #10 Cotton Duck)
30,000 double rubs Wyzenbeek method. End use examples of heavy-duty installations where upholstery fabrics rated at 30,000 double rubs should be appropriate are single shift corporate, hotel rooms/suites, conference rooms and dining area usage.

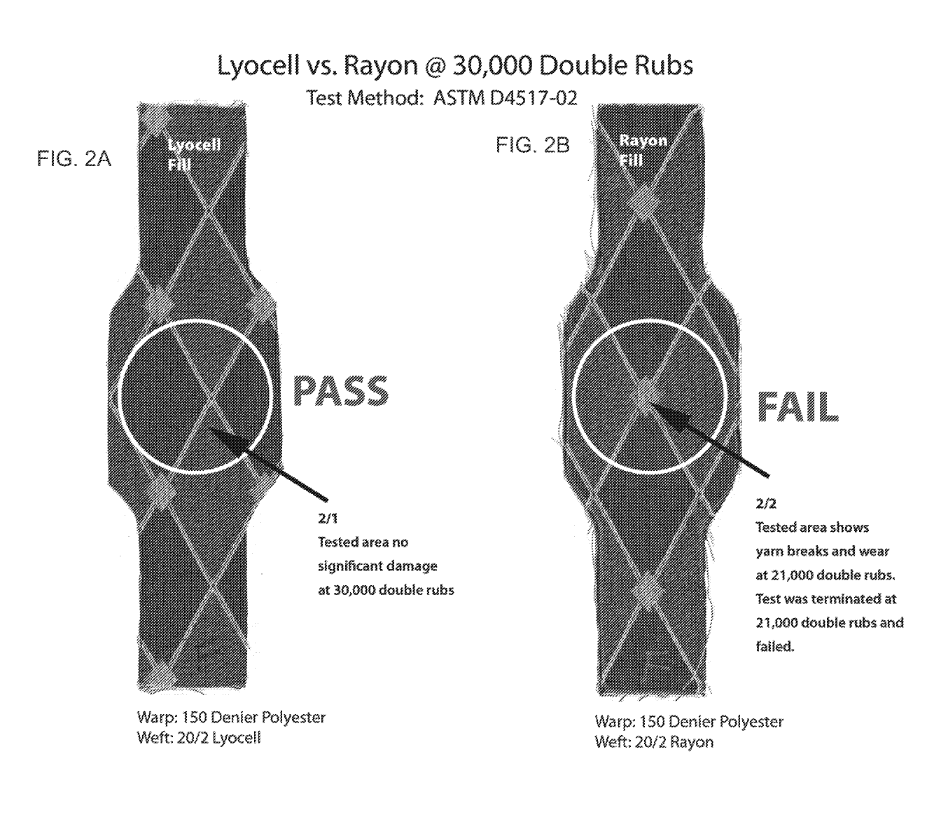

FIGS. 2A and 2B compared final test results of two identical designs in the same construction after 30,000 double rubs. The fabric in FIG. 2A uses ne20/2 lyocell in the fill (weft), whereas the fabric in FIG. 2B uses ne20/2 Rayon in the fill (weft). The warps of both samples are 150 Denier 100% polyester in the two samples tested. Lyocell fill performed well as seen in the area labeled 2/1. It is apparent that the rayon sample noticeably wore out at 21,000 double rubs, as seen at area marked 2/2. The test was terminated at 21,000 doubles rubs, thus failing to perform the necessary 30,000 double rubs.

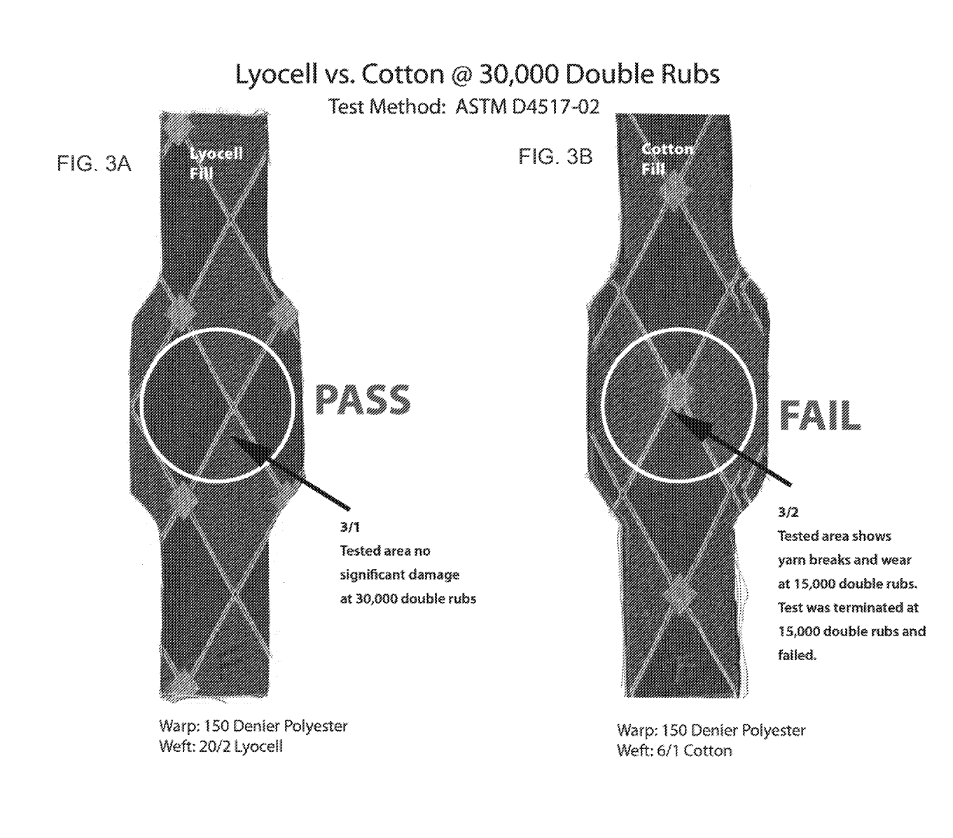

FIGS. 3A and 3B compare a lyocell fill fabric in FIG. 3A to a cotton fill fabric in FIG. 3B. Again, it can be clearly seen that at 30,000 double rubs, there is no considerable damage in FIG. 3A as seen in an area marked 3/1. The cotton fill, however, has considerable damage starting at 15,000 double rubs, as seen in the area marked 3/2. The test for cotton fill was terminated at 15,000 double rubs, thus, failing.

1. A woven fabric, comprising:
a warp formed of natural or manmade fiber; and
a weft formed lyocell fiber or a blend of lyocell fiber and at least one other fiber.

2. The woven fabric according to claim 1, wherein the warp is formed of a synthetic fiber or a cotton fiber and the weft is formed of a lyocell fiber or a lyocell blended fiber.

3. The woven fabric according to claim 1, wherein the warp is formed of a fiber selected from the group consisting of:
a) virgin polyester, recycled polyester or virgin polyester blended with recycled polyester;
b) virgin nylon (polyamide), recycled nylon or virgin nylon blended with recycled nylon;
c) virgin acrylic, recycled acrylic or virgin nylon blended with recycled nylon;
d) lyocell;
e) cotton; and
f) polyester and cotton blended fiber or polyester and cotton yarns used intermittently.

4. The woven fabric according to claim 1, wherein the weft is formed of a fiber selected from the group consisting of:
100% lyocell;
lyocell fiber blended with polyester;
lyocell fiber blended with recycled polyester;
lyocell fiber blended with nylon or recycled nylon;
lyocell fiber blended with cotton; and
lyocell fiber blended with acrylic.

5. The woven fabric according to claim 4, wherein the weft is intermittently used with a fiber selected from the group consisting of:
virgin polyester, recycled polyester or virgin polyester blended with recycled polyester;
virgin nylon (polyamide), recycled nylon or virgin nylon blended with recycled nylon;
virgin acrylic, recycled acrylic or virgin nylon blended with recycled nylon;
lyocell;
cotton; and
polyester and cotton blended yarn or yarn used intermittently.

6. The woven fabric according to claim 1, wherein the warp has a density range of from 25 to 330 yarns per inch, depending size and type of yarns used in the warp.

7. The woven fabric according to claim 1, wherein the weft has a density range of from 10 to 180 yarns per inch, depending size and type of yarns used in the weft.

8. The woven fabric according to claim 1, wherein the fabric is woven as a plain weave, a basket weave, a dobby or a jacquard.

9. The woven fabric according to claim 1, wherein the fabric includes yarns of different color.

10. The woven fabric according to claim 1, wherein the fabric is piece dyed.

11. The woven fabric according to claim 1, wherein the fabric is printed.
